(19) United States
(12) Patent Application Publication
(10) Pub. No.: US 2017/0361510 A1
(43) Pub. Date: Dec. 21, 2017

(54) Method And Apparatus For Molding Dual Cores For A Golf Ball

(71) Applicant: Callaway Golf Company, Carlsbad, CA (US)

(72) Inventor: Vincent Simonds, Brimfield, MA (US)

(73) Assignee: Callaway Golf Company, Carlsbad, CA (US)

(21) Appl. No.: 15/463,868

(22) Filed: Mar. 20, 2017

Related U.S. Application Data
(60) Provisional application No. 62/352,912, filed on Jun. 21, 2016.

(51) Int. Cl. B29C 43/18; B29C 43/02; B29C 43/00; B29C 43/50; B29C 43/52; B29C 43/36; B29L 31/54; B29K 9/00

(52) U.S. Cl. CPC B29C 43/18; B29C 43/52; B29C 43/027; B29C 43/36; B29C 43/003; B29C 43/50; B29C 2043/182; B29K 2009/00; B29L 2031/546

(57) ABSTRACT

A method and apparatus for forming a core for a dual core golf ball is disclosed herein. A headblock is pressed against a mold tool wherein a hemispherical protrusion of the headblock compresses a slug within a first hemispherical cavity to form a first half shell outer core component. An inner core sphere is placed within the first half shell outer core component. An upper section of the mold tool is assembled onto a lower section of the mold tool to place a second half shell outer core component within an upper hemispherical cavity over the inner core sphere within the first hemispherical cavity to form a dual core component for a golf ball.

### CROSS REFERENCES TO RELATED APPLICATIONS

The Present application claims priority to U.S. Provisional Patent Application No. 62/352,912 filed Jun. 21, 2016, which is hereby incorporated by reference in its entirety.

### STATEMENT REGARDING FEDERALLY SPONSORED RESEARCH OR DEVELOPMENT

Not Applicable

### BACKGROUND OF THE INVENTION

### Field of the Invention

The present invention relates to a method and apparatus for molding dual cores for a golf ball.

### Description of the Related Art

The prior art discloses various methods for forming dual cores for golf balls.

U.S. Pat. No. 8,980,151 discloses a method that uses a top plate, a middle plate and a bottom plate to form dual cores for golf balls.

U.S. Pat. No. 7,407,378 also discloses using a top plate, a middle plate and a bottom plate to form dual cores for golf balls.

### BRIEF SUMMARY OF THE INVENTION

The present invention is a method and apparatus for forming a dual core for a golf ball.

The present invention improves yields and centering.

The present invention eliminates steam plant and cooling water.

The present invention is portable and transportable.

The present invention is automatable and decoupled from core demolding.

One aspect of the present invention is a method for forming a core for a dual core golf ball. The method includes placing a slug within a hemispherical cavity of a mold tool. The method also includes pressing a headblock against the mold tool wherein a hemispherical protrusion of the headblock compresses the slug within the first hemispherical cavity to form a first half shell outer core component. The method also includes placing an inner core sphere within the first half shell outer core component. The method also includes assembling an upper section of the mold tool onto the lower section of the mold tool to place a second half shell outer core component within an upper hemispherical cavity over the inner core sphere within the first hemispherical cavity. The method also includes curing the dual core components within the assembled mold tool. The method also includes demolding the dual core components at a cooling station.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a top plan view of a lower section of a mold tool with empty hemispherical cavities.

FIG. 2 an enlarged top plan view of a lower section of a mold tool with empty hemispherical cavities.

FIG. 3 is a top plan view of a lower section of a mold tool with the hemispherical cavities loaded with slugs composed of a polybutadiene based material.

FIG. 4 is an enlarged top plan view of a lower section of a mold tool with the hemispherical cavities loaded with slugs composed of a polybutadiene based material.

FIG. 5 is a top plan view of a lower section of a mold tool after the slugs composed of a polybutadiene based material are pre-formed into half shell core components.

FIG. 6 is a top plan view of a lower section of a mold tool with inner core spheres placed within the half shell core components.

FIG. 7 is a top plan view of a lower section of a mold tool with inner core spheres placed within the half shell core components with alignment pins inserted into the lower section of the mold tool.

FIG. 8 a top plan view of a lower section of a mold tool having hemispherical cavities with half shell core components filled with inner core spheres and an upper lower section of a mold tool having hemispherical cavities with half shell core components.

FIG. 9 is a top plan view of the assembled mold tool with the upper section mated to the lower section.

FIG. 10 is a front elevation view of the assembled mold tool with the upper section mated to the lower section.

FIG. 11 is a top perspective view of the assembled mold tool with the upper section mated to the lower section.

FIG. 12 a top plan view of cured cores demolded from the mold tool.

FIG. 13 is an illustration of the forming stage of the half shell core components.

FIG. 14 is an illustration of the forming stage of the half shell core components in the lower section of the mold tool.

FIG. 15 is an illustration of the forming stage of the half shell core components in the upper section of the mold tool.

FIG. 16 is an illustration of the curing stage of the dual core within the assembled mold tool.

FIG. 17 is a block diagram of the process.

FIG. 18 is an exploded partial cut-away view of a golf ball.

FIG. 19 is top perspective view of a golf ball.

FIG. 20 is a cross-sectional view of a core component of a golf ball.

FIG. 21 is a cross-sectional view of a core component and a mantle component of a golf ball.

FIG. 22 is a cross-sectional view of an inner core layer, an outer core layer, an inner mantle layer, an outer mantle layer and a cover layer of a golf ball.

FIG. 23 is a cross-sectional view of an inner core layer, an intermediate core layer, an outer core layer, a mantle layer and a cover layer of a golf ball.

FIG. 24 is a cross-sectional view of an inner core layer under a 100 kilogram load.

FIG. 25 is a cross-sectional view of a core under a 100 kilogram load.

FIG. 26 is a cross-sectional view of a core component and a mantle component of a golf ball.

FIG. 27 is a cross-sectional view of a core component, the mantle component and a cover layer of a golf ball.

### DETAILED DESCRIPTION OF THE INVENTION

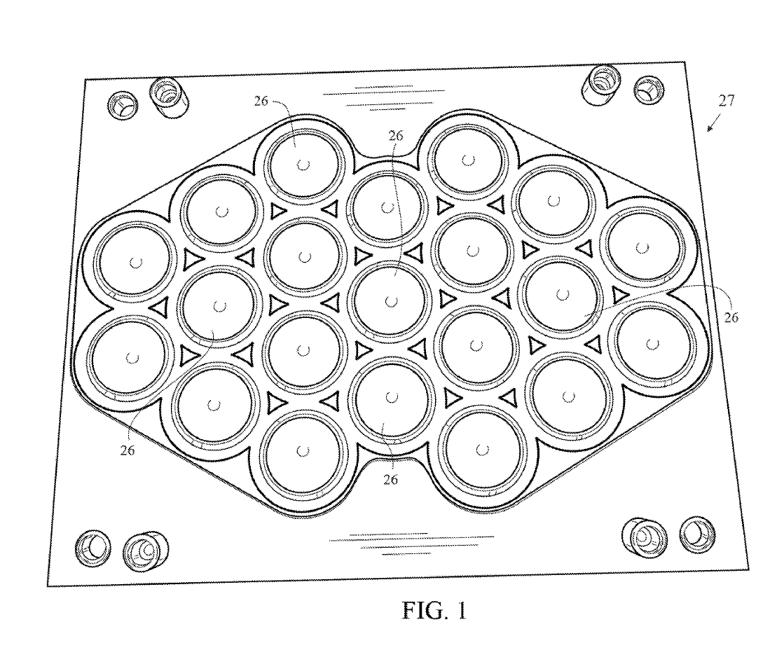

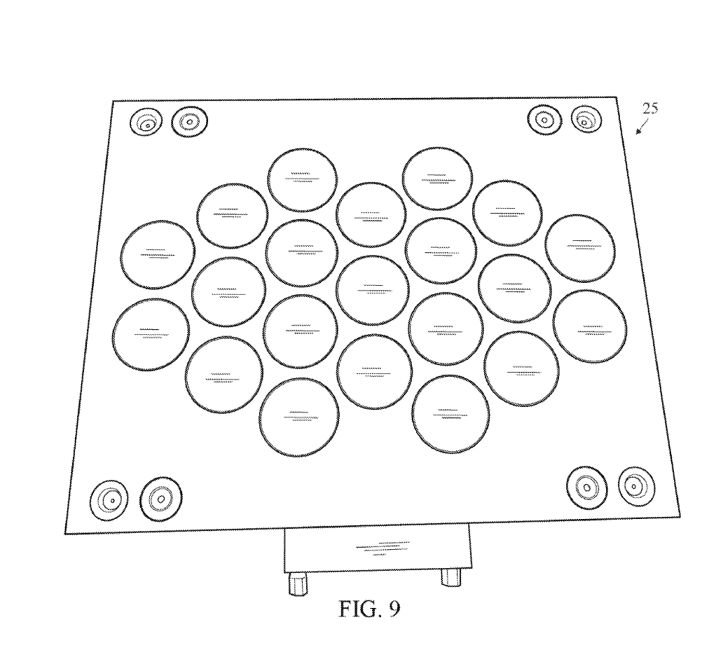

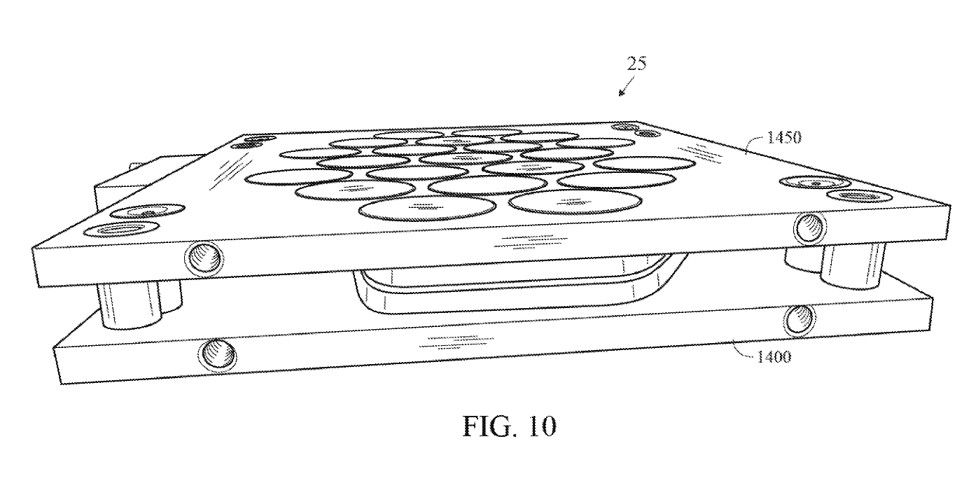

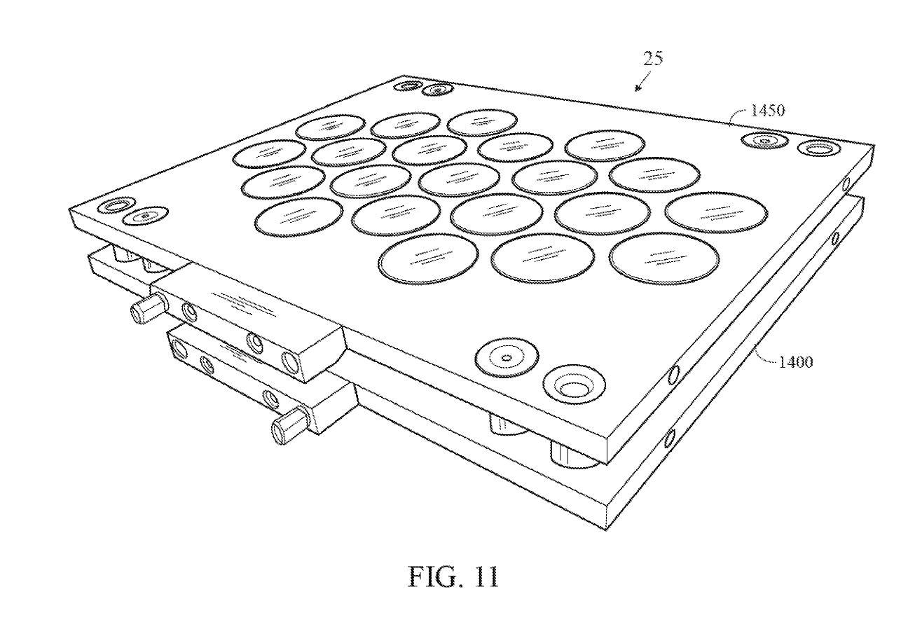

The method and apparatus are illustrated in FIGS. 1-17.

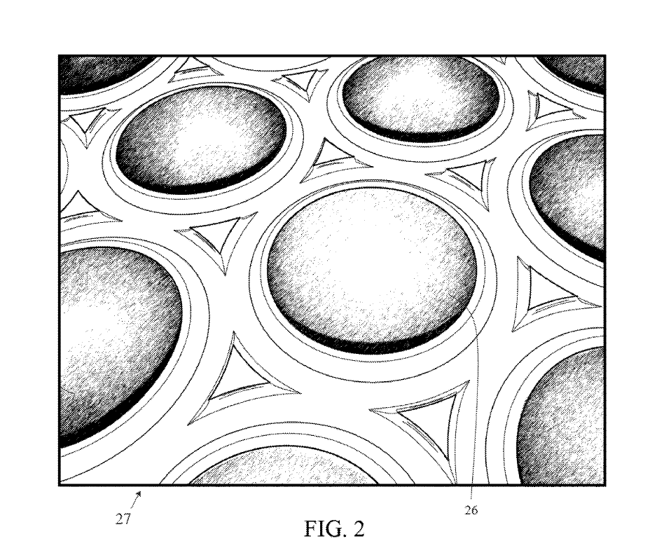

FIGS. 1 and 2 show a press headblock 27 with multiple hemispherical protrusions 26.

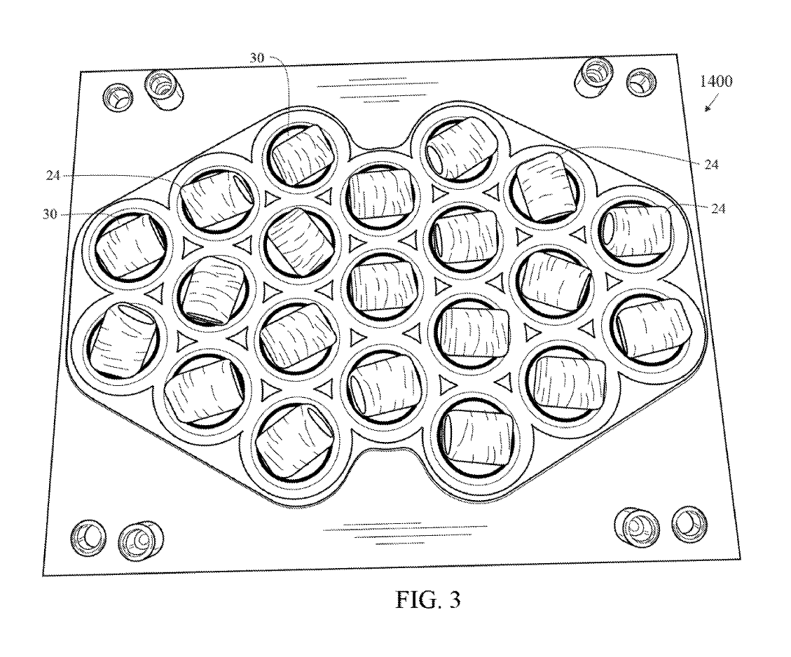

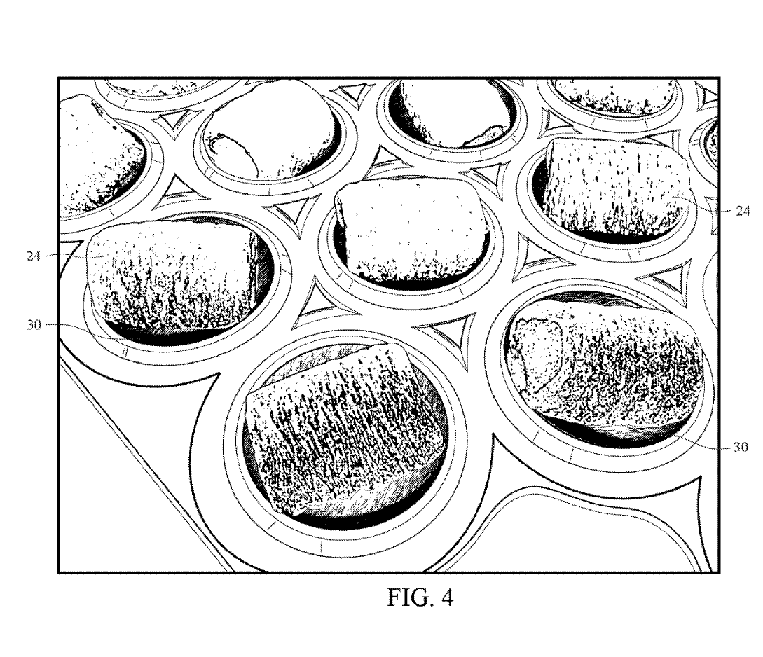

FIGS. 3 and 4 show a bottom section 1400 of a mold tool 25 having multiple hemispherical cavities 30. Each of the hemispherical cavities has a slug 24 of a polybutdiene mixture disposed therein. The slug is preferably composed of a mixture comprising a polybutadiene material, zinc penta chloride, organic peroxide, zinc stearate, zinc diacrylate and zinc oxide.

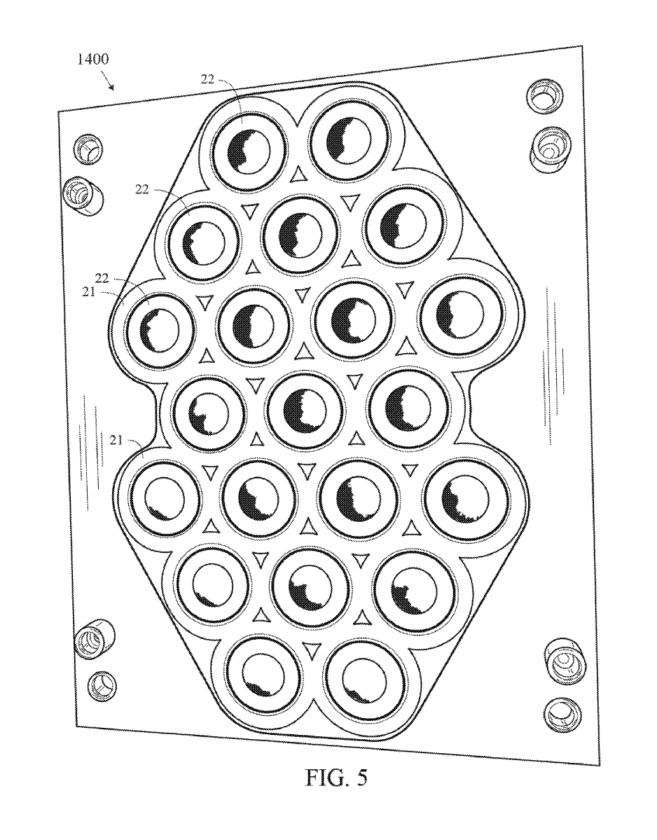

FIG. 5 illustrates the bottom section 1400 of the mold tool 25 subsequent to the pressing step in which the press headblock 27 engages the bottom section 1400 of the mold tool to have each hemispherical protrusion 26 press again a slug in a corresponding hemispherical cavity 30 of the bottom tool 1400 to create the hemispherical core shells 22 and the excess material 21 which flows onto the flat surface of the bottom tool 1400.

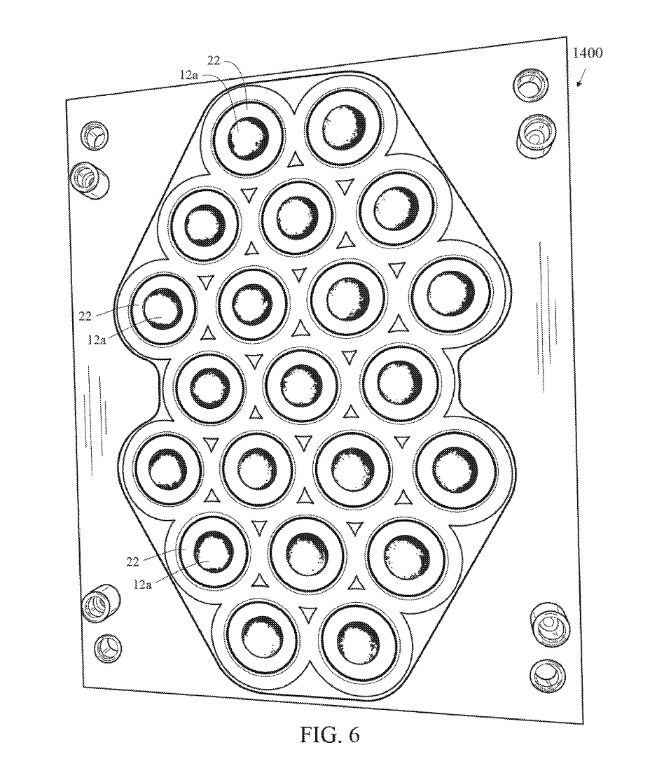

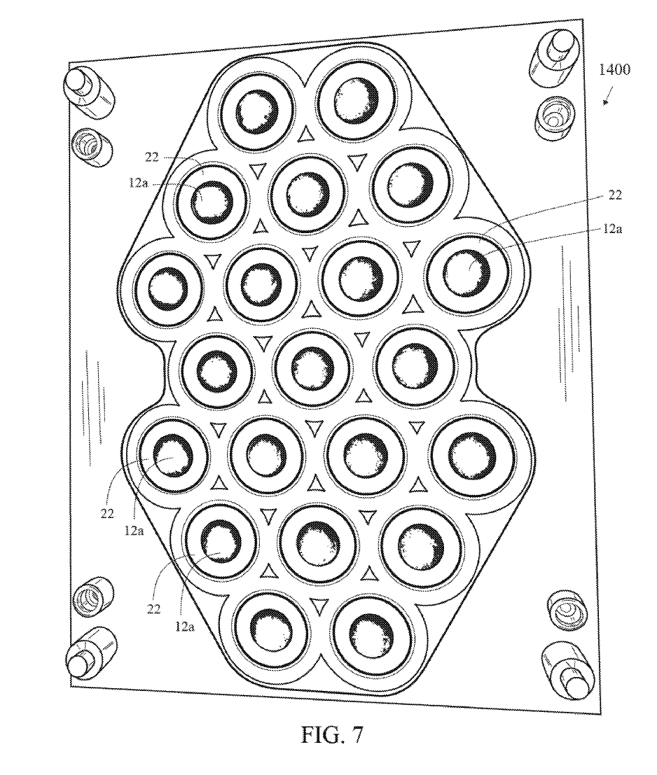

FIGS. 6 and 7 illustrate the bottom section 1400 of the mold tool 25 with inner core spheres 12a placed within each of the hemispherical core shells 22 within each of the hemispherical cavities 30 of the bottom section 1400 of the mold tool 25. Each inner core 12a is previously formed, preferably using a compression molding procedure. Each inner core 12a is preferably composed of a polybutadiene material, zinc penta chloride, organic peroxide, zinc stearate, zinc diacrylate and zinc oxide. Alternatively, each inner core 12a is composed of a highly neutralized polymer such as HPF2000 from DuPont. Alternatively, each inner core 12a is composed of a metal-polymer mixture such as a tungsten polybutadiene mixture.

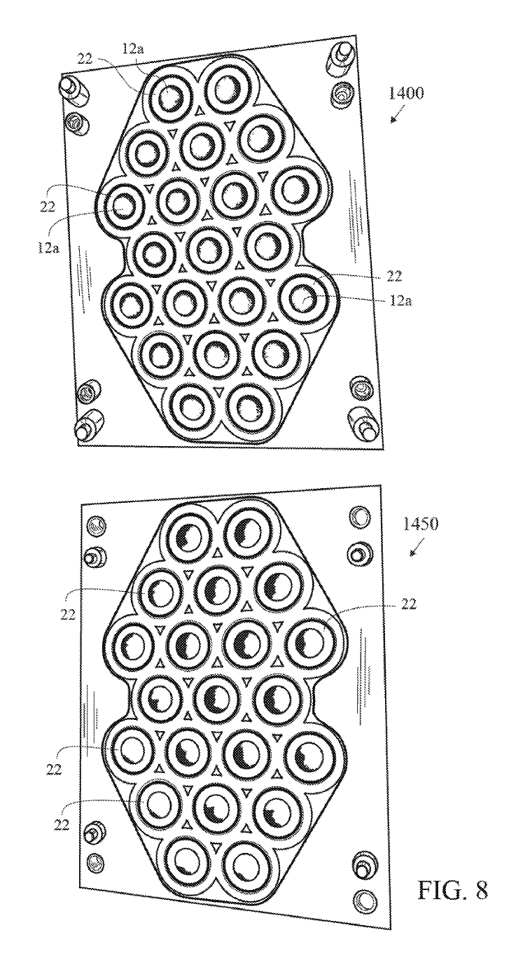

FIG. 8 illustrates a bottom section 1400 and an upper section 1450 of a mold tool 25. The bottom section 1400 inner core spheres 12a placed within each of the hemispherical core shells 22 within each of the hemispherical cavities 30 of the bottom section 1400 of the mold tool 25. The upper section 1450 has hemispherical core shells 22 within hemispherical cavities 30 of the upper section 1450 of the mold tool 25.

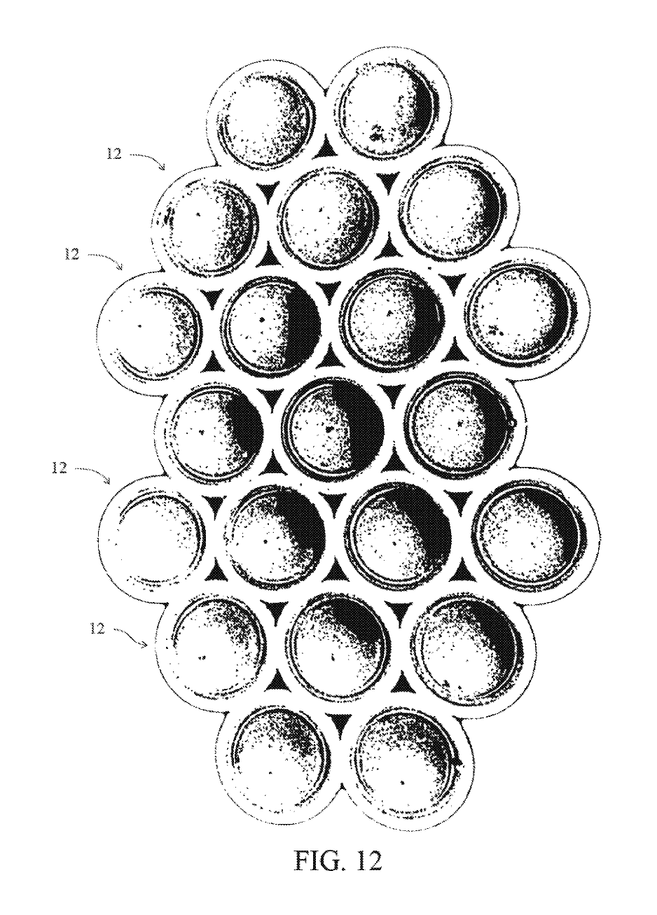

FIGS. 9-11 illustrate the bottom section 1400 engaged with the upper section 1450 to form the complete mold tool 25 in order to form the core 12 composed of the inner core sphere 12a and the outer core shell 12b, as shown in FIG. 12.

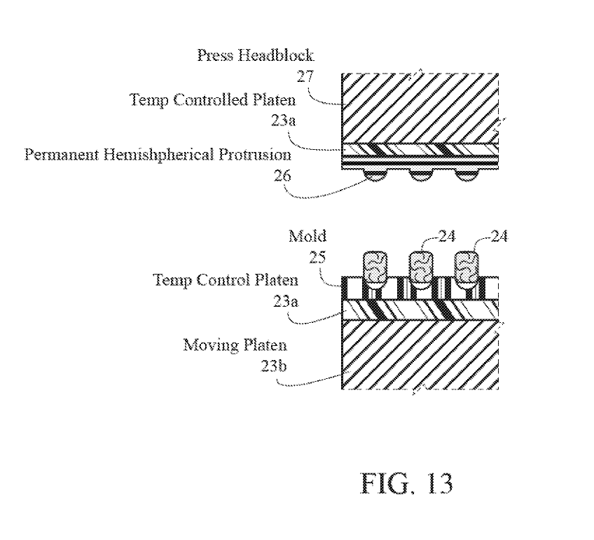

FIG. 13 illustrates a pre-molding step to form the hemispherical core shells 22 within each of the hemispherical cavities 30 of the bottom section 1400 of the mold tool 25. The press headblock 27 comprises a temperature controlled platen 23a and a plurality of hemispherical protrusions 26. The bottom section 1400 of the mold tool 25 has a moving platen 23b, a temperature control platen 23a, multiple hemispherical cavities 30 with a slug 24 of a polybutadiene material therein.

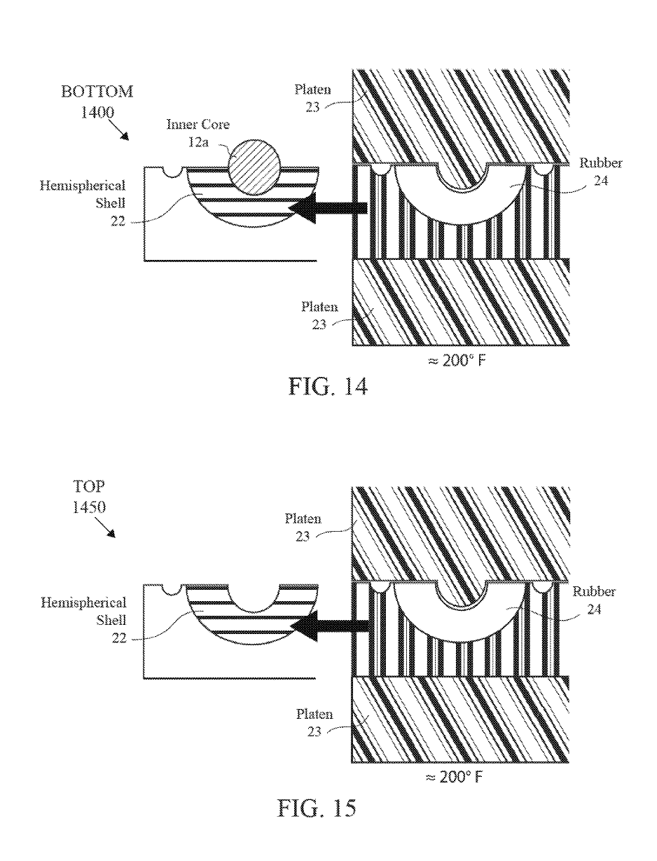

FIG. 14 illustrates the molding step to form the hemispherical core shells 22 within each of the hemispherical cavities 30 of the bottom section 1400 of the mold tool 25. FIG. 14 illustrates the formation of the outer core shell 12b, and the subsequent placement of the inner core 12a therein.

FIG. 15 illustrates the molding step to form the hemispherical core shells 22 within each of the hemispherical cavities 30 of the upper section 1450 of the mold tool 25.

FIG. 16 illustrates the molding step of the full mold tool 25 including the upper section 1450 and the bottom section 1400 engaged to form the core 12 which includes the inner core 12a and the outer core shell 12b.

FIG. 17 illustrates a block diagram of the core manufacturing process 100. Block 101 is the formation of the hemispherical core shells 22 within each of the hemispherical cavities 30 of the bottom section 1400 of the mold tool 25. Block 102 is the placement of the inner cores 12a in each of the hemispherical core shells 22 within each of the hemispherical cavities 30 of the bottom section 1400 of the mold tool 25. Block 103 is the formation of the hemispherical core shells 22 within each of the hemispherical cavities 30 of the upper section 1450 of the mold tool 25. Block 105 is the assembly of the mold tool 25 and the molding of the cores 12. Block 106 is the second stage curing of the cores 12 within the mold tool 25. Block 104 is the demolding of the mold tool 25.

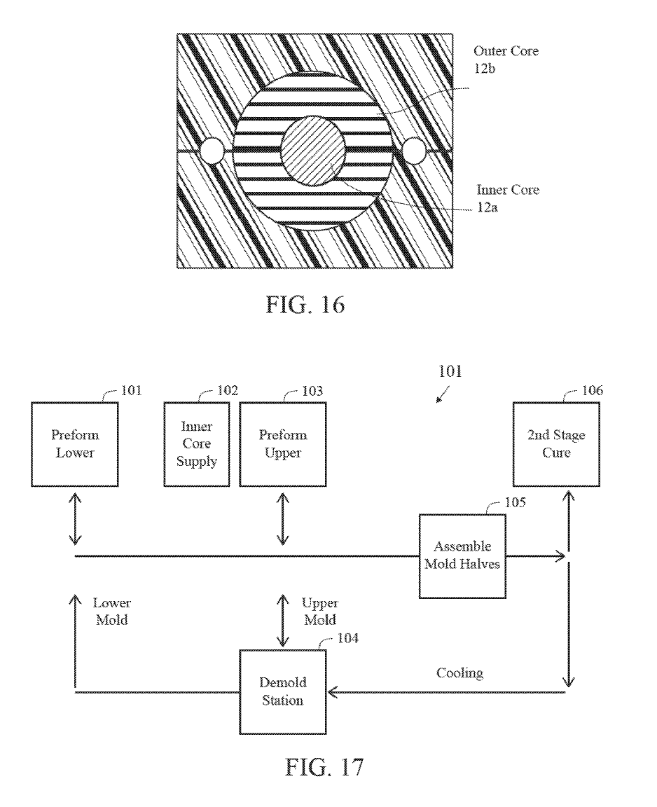

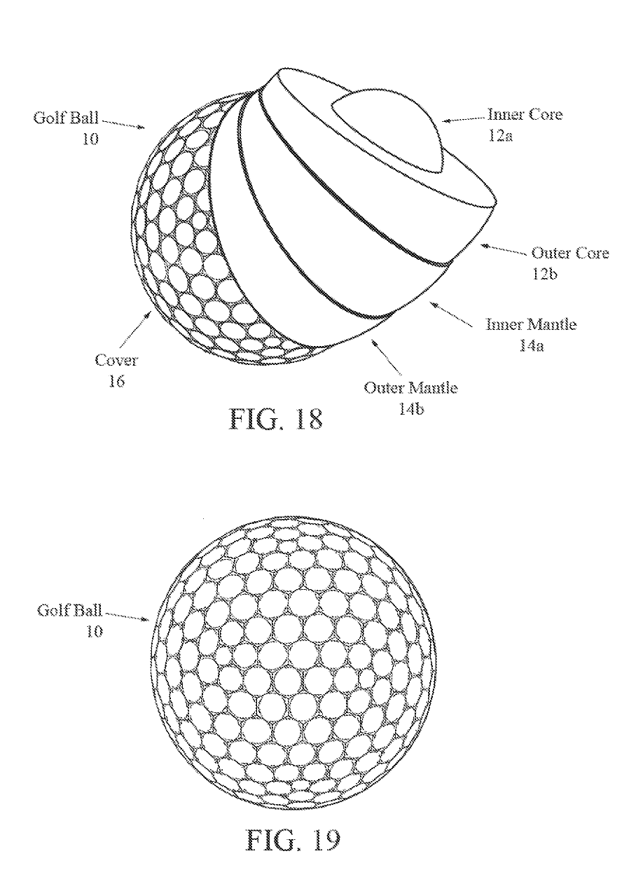

FIGS. 18, 19, 21 and 22 illustrate a five piece golf ball 10 comprising an inner core 12a, an outer core 12b, an inner mantle 14a, an outer mantle 14b, and a cover 16.

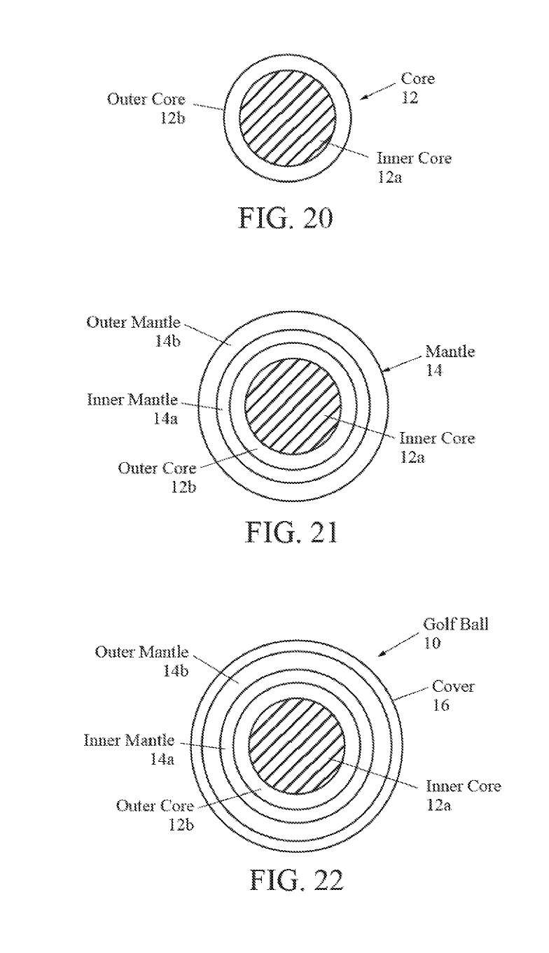

FIG. 20 illustrates a dual core component, comprising an inner core 12a and an outer core 12b.

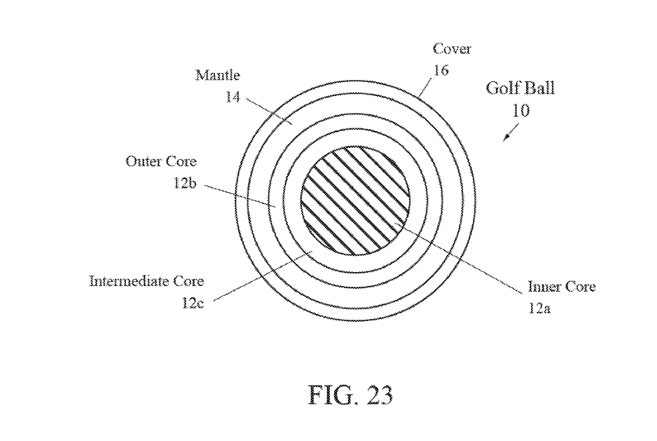

FIG. 23 illustrates a five piece golf ball 10 comprising an inner core 12a, an intermediate core 12b, an outer core 12c, a mantle 14, and a cover 16.

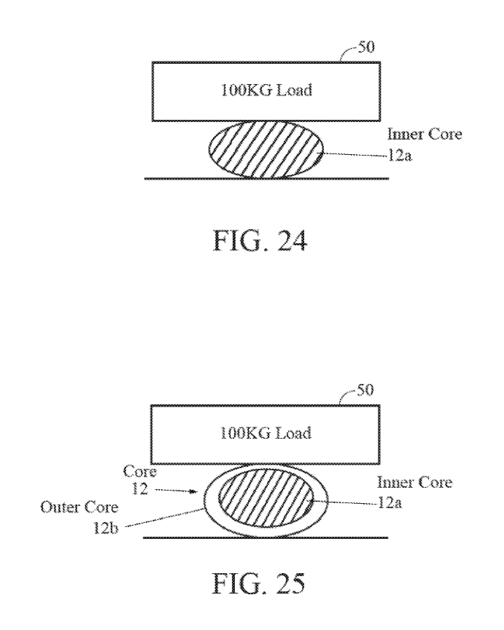

FIGS. 24 and 25 show an inner core 12a under a 100 KG load.

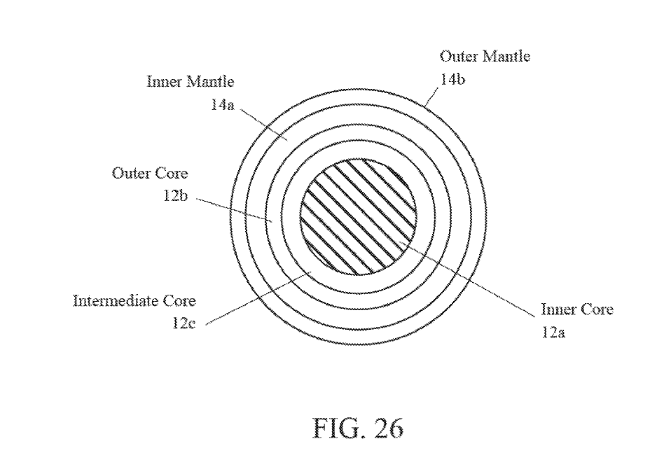

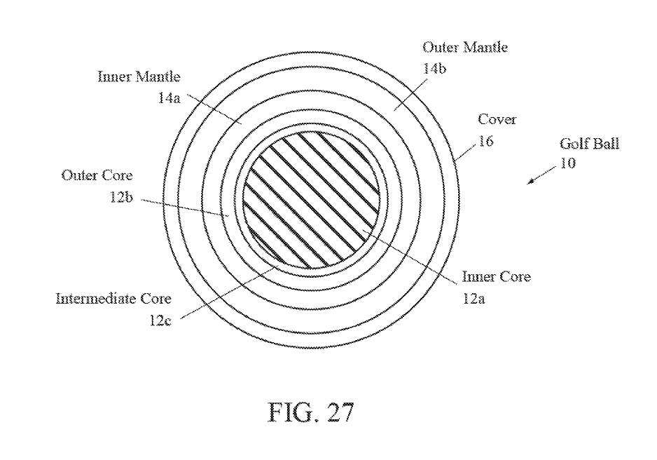

FIGS. 26 and 27 illustrate a six piece golf ball 10 comprising an inner core 12a, an intermediate core 12c, an outer core 12b, an inner mantle 14a, an outer mantle 14b, and a cover 16.

Preferably, the outer core is composed of a polybutadiene material, zinc penta chloride, organic peroxide, zinc stearate, zinc diacrylate and zinc oxide.

In a preferred embodiment, the cover is preferably composed of a thermoplastic polyurethane material, and preferably has a thickness ranging from 0.025 inch to 0.04 inch, and more preferably ranging from 0.03 inch to 0.04 inch. The material of the cover preferably has a Shore D plaque hardness ranging from 30 to 60, and more preferably from 40 to 50. The Shore D hardness measured on the cover is preferably less than 56 Shore D. Preferably the cover 16 has a Shore A hardness of less than 96. Alternatively, the cover 16 is composed of a thermoplastic polyurethane/polyurea material. One example is disclosed in U.S. Pat. No. 7,367,903 for a Golf Ball, which is hereby incorporated by reference in its entirety. Another example is Melanson, U.S. Pat. No. 7,641,841, which is hereby incorporated by reference in its entirety. Another example is Melanson et al, U.S. Pat. No. 7,842,211, which is hereby incorporated by reference in its entirety. Another example is Matroni et al., U.S. Pat. No. 7,867,111, which is hereby incorporated by reference in its entirety. Another example is Dewanjee et al., U.S. Pat. No. 7,785,522, which is hereby incorporated by reference in its entirety.

The mantle component is preferably composed of the inner mantle layer and the outer mantle layer. The mantle component preferably has a thickness ranging from 0.05 inch to 0.15 inch, and more preferably from 0.06 inch to 0.08 inch. The outer mantle layer is preferably composed of a blend of ionomer materials. One preferred embodiment comprises SURLYN 9150 material, SURLYN 8940 material, a SURLYN AD1022 material, and a masterbatch. The SURLYN 9150 material is preferably present in an amount ranging from 20 to 45 weight percent of the cover, and more preferably 30 to 40 weight percent. The SURLYN 8945 is preferably present in an amount ranging from 15 to 35 weight percent of the cover, more preferably 20 to 30 weight percent, and most preferably 26 weight percent. The SURLYN 9945 is preferably present in an amount ranging from 30 to 50 weight percent of the cover, more preferably 35 to 45 weight percent, and most preferably 41 weight percent. The SURLYN 8940 is preferably present in an amount ranging from 5 to 15 weight percent of the cover, more preferably 7 to 12 weight percent, and most preferably 10 weight percent.

SURLYN 8320, from DuPont, is a very-low modulus ethylene/methacrylic acid copolymer with partial neutralization of the acid groups with sodium ions. SURLYN 8945, also from DuPont, is a high acid ethylene/methacrylic acid copolymer with partial neutralization of the acid groups with sodium ions. SURLYN 9945, also from DuPont, is a high acid ethylene/methacrylic acid copolymer with partial neutralization of the acid groups with zinc ions. SURLYN 8940, also from DuPont, is an ethylene/methacrylic acid copolymer with partial neutralization of the acid groups with sodium ions.

The inner mantle layer is preferably composed of a blend of ionomers, preferably comprising a terpolymer and at least two high acid (greater than 18 weight percent) ionomers neutralized with sodium, zinc, magnesium, or other metal ions. The material for the inner mantle layer preferably has a Shore D plaque hardness ranging preferably from 35 to 77, more preferably from 36 to 44, a most preferably approximately 40. The thickness of the outer mantle layer preferably ranges from 0.025 inch to 0.050 inch, and is more preferably approximately 0.037 inch. The mass of an insert including the dual core and the inner mantle layer preferably ranges from 32 grams to 40 grams, more preferably from 34 to 38 grams, and is most preferably approximately 36 grams. The inner mantle layer is alternatively composed of a HPF material available from DuPont. Alternatively, the inner mantle layer 14b is composed of a material such as disclosed in Kennedy, III et al., U.S. Pat. No. 7,361,101 for a Golf Ball And Thermoplastic Material, which is hereby incorporated by reference in its entirety.

The outer mantle layer is preferably composed of a blend of ionomers, preferably comprising at least two high acid (greater than 18 weight percent) ionomers neutralized with sodium, zinc, or other metal ions. The blend of ionomers also preferably includes a masterbatch. The material of the outer mantle layer preferably has a Shore D plaque hardness ranging preferably from 55 to 75, more preferably from 65 to 71, and most preferably approximately 67. The thickness of the outer mantle layer preferably ranges from 0.025 inch to 0.040 inch, and is more preferably approximately 0.030 inch. The mass of the entire insert including the core, the inner mantle layer and the outer mantle layer preferably ranges from 38 grams to 43 grams, more preferably from 39 to 41 grams, and is most preferably approximately 41 grams.

In an alternative embodiment, the inner mantle layer is preferably composed of a blend of ionomers, preferably comprising at least two high acid (greater than 18 weight percent) ionomers neutralized with sodium, zinc, or other metal ions. The blend of ionomers also preferably includes a masterbatch. In this embodiment, the material of the inner mantle layer has a Shore D plaque hardness ranging preferably from 55 to 75, more preferably from 65 to 71, and most preferably approximately 67. The thickness of the outer mantle layer preferably ranges from 0.025 inch to 0.040 inch, and is more preferably approximately 0.030 inch. Also in this embodiment, the outer mantle layer 14b is composed of a blend of ionomers, preferably comprising a terpolymer and at least two high acid (greater than 18 weight percent) ionomers neutralized with sodium, zinc, magnesium, or other metal ions. In this embodiment, the material for the outer mantle layer 14b preferably has a Shore D plaque hardness ranging preferably from 35 to 77, more preferably from 36 to 44, a most preferably approximately 40. The thickness of the outer mantle layer preferably ranges from 0.025 inch to 0.100 inch, and more preferably ranges from 0.070 inch to 0.090 inch.

In other golf balls, the inner mantle layer is thicker than the outer mantle layer and the outer mantle layer is harder than the inner mantle layer, the inner mantle layer is composed of a blend of ionomers, preferably comprising a terpolymer and at least two high acid (greater than 18 weight percent) ionomers neutralized with sodium, zinc, magnesium, or other metal ions. In this embodiment, the material for the inner mantle layer has a Shore D plaque hardness ranging preferably from 30 to 77, more preferably from 30 to 50, and most preferably approximately 40. In this embodiment, the material for the outer mantle layer has a Shore D plaque hardness ranging preferably from 40 to 77, more preferably from 50 to 71, and most preferably approximately 67. In this embodiment, the thickness of the inner mantle layer preferably ranges from 0.030 inch to 0.090 inch, and the thickness of the outer mantle layer ranges from 0.025 inch to 0.070 inch.

Preferably the inner core has a diameter ranging from 0.75 inch to 1.20 inches, more preferably from 0.85 inch to 1.05 inch, and most preferably approximately 0.95 inch. Preferably the inner core 12a has a Shore D hardness ranging from 20 to 50, more preferably from 25 to 40, and most preferably approximately 35. Preferably the inner core is formed from a polybutadiene, zinc diacrylate, zinc oxide, zinc stearate, a peptizer and peroxide. Preferably the inner core has a mass ranging from 5 grams to 15 grams, 7 grams to 10 grams and most preferably approximately 8 grams.

Preferably the outer core has a diameter ranging from 1.25 inch to 1.55 inches, more preferably from 1.40 inch to 1.5 inch, and most preferably approximately 1.5 inch. Preferably the inner core has a Shore D surface hardness ranging from 40 to 65, more preferably from 50 to 60, and most preferably approximately 56. Preferably the inner core is formed from a polybutadiene, zinc diacrylate, zinc oxide, zinc stearate, a peptizer and peroxide. Preferably the combined inner core and outer core have a mass ranging from 25 grams to 35 grams, 30 grams to 34 grams and most preferably approximately 32 grams.

Preferably the inner core has a deflection of at least 0.230 inch under a load of 220 pounds, and the core has a deflection of at least 0.080 inch under a load of 200 pounds. As shown in FIGS. 24 and 25, a mass 50 is loaded onto an inner core and a core. As shown in FIGS. 6 and 7, the mass is 100 kilograms, approximately 220 pounds. Under a load of 100 kilograms, the inner core preferably has a deflection from 0.230 inch to 0.300 inch. Under a load of 100 kilograms, preferably the core has a deflection of 0.08 inch to 0.150 inch. Alternatively, the load is 200 pounds (approximately 90 kilograms), and the deflection of the core 12 is at least 0.080 inch. Further, a compressive deformation from a beginning load of 10 kilograms to an ending load of 130 kilograms for the inner core ranges from 4 millimeters to 7 millimeters and more preferably from 5 millimeters to 6.5 millimeters. The dual core deflection differential allows for low spin off the tee to provide greater distance, and high spin on approach shots.

In an alternative embodiment of the golf ball shown in FIG. 23, the golf ball 10 comprises an inner core 12a, an intermediate core 12b, an outer core 12b, a mantle 14 and a cover 16. The golf ball 10 preferably has a diameter of at least 1.68 inches, a mass ranging from 45 grams to 47 grams, a COR of at least 0.79, a deformation under a 100 kilogram loading of at least 0.07 mm.

In one embodiment, the golf ball comprises a core, a mantle layer and a cover layer. The core comprises an inner core sphere, an intermediate core layer and an outer core layer. The inner core sphere comprises a polybutadiene material and has a diameter ranging from 0.875 inch to 1.4 inches. The intermediate core layer is composed of a highly neutralized ionomer and has a Shore D hardness less than 40. The outer core layer is composed of a highly neutralized ionomer and has a Shore D hardness less than 45. A thickness of the intermediate core layer is greater than a thickness of the outer core layer. The mantle layer is disposed over the core, comprises an ionomer material and has a Shore D hardness greater than 55. The cover layer is disposed over the mantle layer comprises a thermoplastic polyurethane material and has a Shore A hardness less than 100. The golf ball has a diameter of at least 1.68 inches. The mantle layer is harder than the outer core layer, the outer core layer is harder than the intermediate core layer, the intermediate core layer is harder than the inner core sphere, and the cover layer is softer than the mantle layer.

In another golf ball, shown in FIGS. 26 and 27, the golf ball 10 has a multi-layer core and multi-layer mantle. The golf ball includes a core, a mantle component and a cover layer. The core comprises an inner core sphere, an intermediate core layer and an outer core layer. The inner core sphere comprises a polybutadiene material and has a diameter ranging from 0.875 inch to 1.4 inches. The intermediate core layer is composed of a highly neutralized ionomer and has a Shore D hardness less than 40. The outer core layer is composed of a highly neutralized ionomer and has a Shore D hardness less than 45. A thickness of the intermediate core layer is greater than a thickness of the outer core layer 12c. The inner mantle layer is disposed over the core, comprises an ionomer material and has a Shore D hardness greater than 55. The outer mantle layer is disposed over the inner mantle layer, comprises an ionomer material and has a Shore D hardness greater than 60. The cover layer is disposed over the mantle component, comprises a thermoplastic polyurethane material and has a Shore A hardness less than 100. The golf ball has a diameter of at least 1.68 inches. The outer mantle layer is harder than the inner mantle layer, the inner mantle layer is harder than the outer core layer, the outer core layer is harder than the intermediate core layer, the intermediate core layer is harder than the inner core sphere, and the cover layer is softer than the outer mantle layer.

In a particularly preferred embodiment of the invention, the golf ball preferably has an aerodynamic pattern such as disclosed in Simonds et al., U.S. Pat. No. 7,419,443 for a Low Volume Cover For A Golf Ball, which is hereby incorporated by reference in its entirety. Alternatively, the golf ball has an aerodynamic pattern such as disclosed in Simonds et al., U.S. Pat. No. 7,338,392 for An Aerodynamic Surface Geometry For A Golf Ball, which is hereby incorporated by reference in its entirety.

Various aspects of the present invention golf balls have been described in terms of certain tests or measuring procedures. These are described in greater detail as follows.

As used herein, “Shore D hardness” of the golf ball layers is measured generally in accordance with ASTM D-2240 type D, except the measurements may be made on the curved surface of a component of the golf ball, rather than on a plaque. If measured on the ball, the measurement will indicate that the measurement was made on the ball. In referring to a hardness of a material of a layer of the golf ball, the measurement will be made on a plaque in accordance with ASTM D-2240. Furthermore, the Shore D hardness of the cover is measured while the cover remains over the mantles and cores. When a hardness measurement is made on the golf ball, the Shore D hardness is preferably measured at a land area of the cover.

As used herein, “Shore A hardness” of a cover is measured generally in accordance with ASTM D-2240 type A, except the measurements may be made on the curved surface of a component of the golf ball, rather than on a plaque. If measured on the ball, the measurement will indicate that the measurement was made on the ball. In referring to a hardness of a material of a layer of the golf ball, the measurement will be made on a plaque in accordance with ASTM D-2240. Furthermore, the Shore A hardness of the cover is measured while the cover remains over the mantles and cores. When a hardness measurement is made on the golf ball, Shore A hardness is preferably measured at a land area of the cover

The resilience or coefficient of restitution (COR) of a golf ball is the constant “e,” which is the ratio of the relative velocity of an elastic sphere after direct impact to that before impact. As a result, the COR (“e”) can vary from 0 to 1, with 1 being equivalent to a perfectly or completely elastic collision and 0 being equivalent to a perfectly or completely inelastic collision.

COR, along with additional factors such as club head speed, club head mass, ball weight, ball size and density, spin rate, angle of trajectory and surface configuration as well as environmental conditions (e.g. temperature, moisture, atmospheric pressure, wind, etc.) generally determine the distance a ball will travel when hit. Along this line, the distance a golf ball will travel under controlled environmental conditions is a function of the speed and mass of the club and size, density and resilience (COR) of the ball and other factors. The initial velocity of the club, the mass of the club and the angle of the ball's departure are essentially provided by the golfer upon striking. Since club head speed, club head mass, the angle of trajectory and environmental conditions are not determinants controllable by golf ball producers and the ball size and weight are set by the U.S.G.A., these are not factors of concern among golf ball manufacturers. The factors or determinants of interest with respect to improved distance are generally the COR and the surface configuration of the ball.

The coefficient of restitution is the ratio of the outgoing velocity to the incoming velocity. In the examples of this application, the coefficient of restitution of a golf ball was measured by propelling a ball horizontally at a speed of 125+/−5 feet per second (fps) and corrected to 125 fps against a generally vertical, hard, flat steel plate and measuring the ball's incoming and outgoing velocity electronically. Speeds were measured with a pair of ballistic screens, which provide a timing pulse when an object passes through them. The screens were separated by 36 inches and are located 25.25 inches and 61.25 inches from the rebound wall. The ball speed was measured by timing the pulses from screen 1 to screen 2 on the way into the rebound wall (as the average speed of the ball over 36 inches), and then the exit speed was timed from screen 2 to screen 1 over the same distance. The rebound wall was tilted 2 degrees from a vertical plane to allow the ball to rebound slightly downward in order to miss the edge of the cannon that fired it. The rebound wall is solid steel.

As indicated above, the incoming speed should be 125±5 fps but corrected to 125 fps. The correlation between COR and forward or incoming speed has been studied and a correction has been made over the ±5 fps range so that the COR is reported as if the ball had an incoming speed of exactly 125.0 fps.

The measurements for deflection, compression, hardness, and the like are preferably performed on a finished golf ball as opposed to performing the measurement on each layer during manufacturing.

Preferably, in a five layer golf ball comprising an inner core, an outer core, an inner mantle layer, an outer mantle layer and a cover, the hardness/compression of layers involve an inner core with the greatest deflection (lowest hardness), an outer core (combined with the inner core) with a deflection less than the inner core, an inner mantle layer with a hardness less than the hardness of the combined outer core and inner core, an outer mantle layer with the hardness layer of the golf ball, and a cover with a hardness less than the hardness of the outer mantle layer. These measurements are preferably made on a finished golf ball that has been torn down for the measurements.

Preferably the inner mantle layer is thicker than the outer mantle layer or the cover layer. The dual core and dual mantle golf ball creates an optimized velocity-initial velocity ratio (Vi/IV), and allows for spin manipulation. The dual core provides for increased core compression differential resulting in a high spin for short game shots and a low spin for driver shots. A discussion of the USGA initial velocity test is disclosed in Yagley et al., U.S. Pat. No. 6,595,872 for a Golf Ball With High Coefficient Of Restitution, which is hereby incorporated by reference in its entirety. Another example is Bartels et al., U.S. Pat. No. 6,648,775 for a Golf Ball With High Coefficient Of Restitution, which is hereby incorporated by reference in its entirety.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

1. A method for forming a dual core component for a golf ball, the method comprising:
placing a slug within a hemispherical cavity of a plurality of hemispherical cavities of a lower section of a mold tool, the lower section comprising a temperature control platen positioned below the plurality of hemispherical cavities and a moving platen positioned below the temperature control platen;
pressing a headblock against the mold tool wherein a hemispherical protrusion of a plurality of hemispherical protrusions of the headblock compresses the slug within the first hemispherical cavity to form a first half shell outer core component, the headblock comprising a temperature controlled platen for heating the headblock during the pressing step;
placing an inner core sphere within the first half shell outer core component;
assembling an upper section of the mold tool onto the lower section of the mold tool to place a second half shell outer core component within a second hemispherical cavity over the inner core sphere within the first hemispherical cavity;
curing the dual core component in the assembled mold tool; and
demolding the dual core component.

2. The method according to claim 1 wherein the inner core sphere is composed of a polybutadiene based material.

3-4. (canceled)

5. The method according to claim 1 wherein the temperature controlled platen of the lower mold section is heated to a temperature ranging from 100° F. to 250° F. during the pressing step.

6. The method according to claim 1 further comprising conveying the assembled mold tool to a cooling station subsequent to the curing step.

7. The method according to claim 6 wherein the demolding is performed at the cooling station.

8. The method according to claim 1 further comprising forming a slug.

9. The method according to claim 1 wherein the number of hemispherical cavities ranges from ten to thirty.

10-13. (canceled)

14. A method for forming a dual core component for a golf ball, the method comprising:
placing a slug within each of a plurality of hemispherical cavities of a lower section and an upper section of a mold tool, the lower section comprising a temperature control platen positioned below the plurality of hemispherical cavities and a moving platen positioned below the temperature control platen;
pressing a headblock against the mold tool wherein a hemispherical protrusion of the headblock compresses the slug within each of the plurality of hemispherical cavities to form a half shell outer core component, the headblock comprising a temperature controlled platen for heating the headblock during the pressing step;
placing an inner core sphere within the half shell outer core component of each of the plurality of hemispherical cavities of the lower section;
assembling an upper section of the mold tool onto the lower section of the mold tool to place a second half shell outer core component within each of the plurality of hemispherical cavities of the upper section over the inner core sphere within the half shell outer core component of each of the plurality of hemispherical cavities of the lower section;
curing the dual core component in the assembled mold tool; and
demolding the dual core component.

15. The method according to claim 14 wherein the inner core sphere is composed of a polybutadiene based material.

16-17. (canceled)

18. The method according to claim 14 wherein the temperature controlled platen of the lower mold section is heated to a temperature ranging from 100° F. to 250° F. during the pressing step.

19. The method according to claim 14 further comprising conveying the assembled mold tool to a cooling station subsequent to the curing step.

20. The method according to claim 19 wherein the demolding is performed at the cooling station.
